(19) United States
(12) Patent Application Publication
(10) Pub. No.: US 2011/0091850 A1
(43) Pub. Date: Apr. 21, 2011

(54) Vision application training device

(76) Inventor: Len Bilous, Whitehall, PA (US)

(21) Appl. No.: 12/587,817

(22) Filed: Oct. 15, 2009

(51) Int. Cl. G09B 19/00; G08B 23/00

(52) U.S. Cl. 434/247; 340/573.1

(57) ABSTRACT

The present invention is directed to a vision applications training device prevent head tilting when appropriate, which comprises: a main housing; an ear attachment means connected to the main housing, and having a first and second component connected to one another to be movable relative to one another from a first, open, position to a second, closed, position and arranged to create the closed position for fixed placement on a human ear; a speaking tilt alarm system within the main housing includes a battery, a sound chip, a speaker, a tilt activation mechanism and functional connections, the sound chip having at least one speaking command; and, wherein a user may attach the device to the user's ear and when the user's head tilts at least a predetermined angle from horizontal, the tilt activation mechanism activates the chip and the at least one speaking command is played through the speaker.

### BACKGROUND OF INVENTION

a. Field of Invention

The invention relates generally to a training device that may be used for visual applications training, that is, vocational, hobby, recreational or sports training wherein it is desirable for a trainee to not look down. More specifically, the present invention relates to a device that opens and closes and is securely fastened to a human ear.

b. Description of Related Art

The following patents are representative of the field pertaining to the present invention:

U.S. Pat. No. 6,331,168 to Socci et al. describes an apparatus and method for using head gear to sense the motion of the wearer's head and output a signal indicative of the motion. Sensors are used to detect head motion about two mutually perpendicular axes. The sensor signal is fed into a microprocessor to compute a feedback signal indicative of the deviation of the motion from a desired, preprogrammed path. The feedback signal is delivered to an indicator to alert the wearer of the head motion. The device is adaptable to monitor head motions for various athletic, sporting and safety applications.

U.S. Pat. No. 6,147,612 to Ruan et al. describes a dual function sleep preventing system comprising a micro optic eyelid monitor, a micro optic tilting monitor, a signal combination circuits and an alarming unit. The eyelid monitor is placed in the vicinity of an eye by an appropriate mounting device when in use, using an emitter to transmit modulated appropriate light signals towards the eye, and using optic sensors to sense the influenced light by the eyelid, to detect the movement of eyelid. The tilting monitor comprises an optic tilt switch set on the side head of a user, using a micro optic monitor to detect a small ball's rolling in a closed tube system inside the switch when tilting. Both the monitors are connected to a signal combination circuits, which has an input signal filtering device, a switch part and a counter. The filtering device sets an appropriate time delay range to pick up dangerous long symptoms, base on signal length and the difference between a monitor signal's appearing time and another monitor's. The counter circuits records the times of those signals' occurrence. When finding such a symptom, the combination circuits will stimulate a pre-alarming immediately to detect the sleepy state of a user. A fully alarming will follow if the user has no response after a limited waiting time, or if the times of repeating pre-alarming reaches a criteria value set in the counter.

U.S. Pat. No. 6,048,324 to Socci et al. describes an apparatus and method for using head gear to sense the motion of the wearer's head and output a signal indicative of the motion. Sensors are used to detect head motion about two mutually perpendicular axes. The sensor signal is fed into a microprocessor to compute a feedback signal indicative of the deviation of the motion from a desired, preprogrammed path. The feedback signal is delivered to an indicator to alert the wearer of the head motion. The device is adaptable to monitor head motions for various athletic, sporting and safety applications.

U.S. Pat. No. 5,841,354 to Bae et al. describes a position-sensing waking system and method that includes an ear plug for slidably inserting into an ear of a person, a housing rotatably connected with the ear plug, an alarm mechanism for generating an alarm sound, a detection switch disposed inside the housing, a control circuit for controlling the position-sensing waking system, and a battery for supplying power to the position-sensing waking system, the housing containing the alarm system, the system switch, the detection switch, the control circuit and the battery, wherein the detection switch is activated according to a movement of the ear to generate the alarm sound by the alarm mechanism.

U.S. Pat. No. 5,684,461 to Jones describes a sleep prevention device for a driver of a vehicle including a head set with a U-shaped configuration. Also included is a mercury switch assembly with at least one mercury switch. Mercury resides within each mercury switch and closes contacts located therein upon a head of the driver tilting forward or rearwardly. Upon the closing of such and closes activation signal may be transmitted. Further provided is an alarm unit including an alarm for indicating to the driver the receipt of the activation signal. The alarm unit is connected to contacts of the mercury switches, the alarm, and a power source and further adapted to transmit an alarm signal to the alarm upon the transmission of the activation signal.

U.S. Pat. No. 5,558,585 to Nolan, Jr. describes a device for detecting head movement of an individual during an activity of the individual is provided. The device includes a weighted wheel for establishing a reference with respect to an initial position of the individual's head, and a first angular encoder and second angular encoder for detecting angular movement of the head with respect to the reference. The detected head movement is processed by a controller and the output is provided by a display and a speaker.

U.S. Pat. No. 5,430,435 to Hoch et al. describes an athletic training system that includes a position processor which can be mounted on the head of an athlete by means of, for example, a head band. The position processor includes a sensor in the form of two tilt sensors mounted at right angles to each other. The direction of tilt is sampled by a microprocessor as output voltages from the sensors for further processing. Software of the microprocessor processes the sensed directions by filtering and hysterisis algorithms in order to eliminate rapid changes of state of the switches of the sensor due to sporadic movement caused by the motion of the athlete. The positional information is conveyed to the athlete as a pattern of lights and tones. Proper and improper head positions are indicated for a plurality of directions of tilt. The training system is user controllable by means of rotary switches to adjust, among other things, the level of sensitivity of the system. The system can also self-center by adjusting all sampled directions by a sampled reference value.

U.S. Pat. No. 3,999,177 to Greene describes an apparatus for keeping a vehicle operator awake by means of an audible alarm or signal responsive to a nodding or tilting forward movement of the head of the operator of the vehicle. The apparatus includes a switch mounted on a hat, car hook or head band, worn by the vehicle operator and which switch is closed upon the tilting forward of the operator's head to complete an electrical circuit providing power from a battery to an alarm. The battery and alarm may be enclosed in a casing which may be clipped to the operator's wearing apparel, or mounted on the dash board of a vehicle and a flexible electrical line interconnects the hat, head band or ear hook and the casing or dash board to permit freedom of operator movement; also, an electrical connector may be provided on the flexible electrical line to permit the hat, head band or ear hook and casing or dashboard to be electrically and mechanically disconnected. A manually operable switch is provided to permit the alarm means to be selectively turned on or off.

U.S. Pat. No. 3,906,478 to Smey describes a hollow shallow cylindrical member that is provided with a clip for detachably securing the member to an ear of a driver of a vehicle or other user. The member transmits external noise to the ear and is also provided with a battery powered buzzer turned on by a normally open mercury containing tilt switch when the user's head tilts forward, sideways or backward at an angle of at least 40°. The noise of the buzzer prevents the user from falling asleep.

Notwithstanding the prior art, the present invention is neither taught nor rendered obvious thereby.

### SUMMARY OF INVENTION

The present invention is directed to a vision applications training device to assist a user in preventing head tilting in environments where it is appropriate, which comprises: a main housing; an ear attachment mechanism connected to the main housing, the ear attachment mechanism having a first component and second component being connected to one another so as to be movable relative to one another from a first position, being an open position, to a second position, being a closed position, and arranged to create the closed position for fixed placement on a human ear; a speaking tilt alarm system contained within the main housing that includes a battery, a sound chip, a speaker, a tilt activation mechanism and functional connections, the sound chip having at least one speaking command; and, wherein a user may attach the device to the user's ear and when the user's head tilts at least a predetermined angle from horizontal, the tilt activation mechanism activates the chip and the at least one speaking command is played through the speaker.

In some preferred embodiments of the present invention the vision applications training device the main housing includes a battery access mechanism to permit battery replacement.

In some preferred embodiments of the present invention the vision applications training device the tilt activation mechanism is a mercury switch with a non-horizontal orientation of predetermined angle.

In some preferred embodiments of the present invention the vision applications training device the tilt activation mechanism is a digital level sensor.

In some preferred embodiments of the present invention the vision applications training device the tilt activation mechanism is a floating contact ball with a non-horizontal oriented ball track.

In some preferred embodiments of the present invention the vision applications training device the device further includes padding attached to a portion of the device to reduce impact-based head injury.

In some preferred embodiments of the present invention the vision applications training device further including: a speaking instructions system that further at least includes a battery connection, a sound chip, a speaker and a programmed control chip for playing the sound chip at preset intervals, the sound chip having at least one speaking instruction.

In some preferred embodiments of the present invention the vision applications training device the speaking instructions system battery connection is functionally connected to the speaking tilt alarm system battery.

In some preferred embodiments of the present invention the vision applications training device the speaking instructions system includes an off-on control switch.

In some preferred embodiments of the present invention the vision applications training device the speaking tilt alarm system includes an off-on control switch.

In some preferred embodiments of the present invention the vision applications training device the first component and the second component are connected to one another by a movement mechanism selected from the group consisting of a rotation mechanism, a slide mechanism and a stretch mechanism.

In some preferred embodiments of the present invention the vision applications training device the first component is an elastic component and the second component is a non-elastic component being connected to one another to create a closed expandable-contractible loop.

In some other preferred embodiments of the present invention a vision applications training device to assist a user in preventing head tilting in environments where it is appropriate: a main housing; an ear attachment mechanism connected to the main housing, the ear attachment mechanism having a first component and second component being connected to one another so as to be movable relative to one another from a first position, being an open position, to a second position, being a closed position, and arranged to create the closed position for fixed placement on a human ear; a speaking tilt alarm system contained within the main housing that includes a battery, a sound chip, a speaker, a tilt activation mechanism and functional connections, the sound chip having at least one speaking command; wherein a user may attach the device to the user's ear and when the user's head tilts at least a predetermined angle from horizontal, the tilt activation mechanism activates the chip and the at least one speaking command is played through the speaker.

In some preferred embodiments of the present invention the vision applications training methodology for environments where it is appropriate to prevent head tilting the step a) involves using the vision applications training device, wherein the main housing includes a battery access mechanism to permit battery replacement.

In some preferred embodiments of the present invention the vision applications training methodology for environments where it is appropriate to prevent head tilting the step a) involves using the vision applications training device, wherein the tilt activation mechanism is a mercury switch with a non-horizontal orientation of predetermined angle.

In some preferred embodiments of the present invention the vision applications training methodology for environments where it is appropriate to prevent head tilting the step a) involves using the vision applications training device, wherein the tilt activation mechanism is a digital level sensor.

In some preferred embodiments of the present invention the vision applications training methodology for environments where it is appropriate to prevent head tilting the step a) involves using the vision applications training device, wherein the tilt activation mechanism is a floating contact ball with a non-horizontal oriented ball track.

In some preferred embodiments of the present invention the vision applications training methodology for environments where it is appropriate to prevent head tilting the step a) involves using the vision applications training device, wherein the device further includes padding attached to a portion of the device to reduce impact-based head injury.

In some preferred embodiments of the present invention the vision applications training methodology for environments where it is appropriate to prevent head tilting the step a) involves using the vision applications training device, wherein the vision applications training device further includes: a speaking instructions system that further at least includes a battery connection, a sound chip, a speaker and a programmed control chip for playing the sound chip at preset intervals, the sound chip having at least one speaking instruction.

In some preferred embodiments of the present invention the vision applications training methodology for environments where it is appropriate to prevent head tilting the step a) involves using the vision applications training device, wherein the speaking instructions system battery connection is functionally connected to the speaking tilt alarm system battery.

In some preferred embodiments of the present invention the vision applications training methodology for environments where it is appropriate to prevent head tilting the step a) involves using the vision applications training device, wherein the speaking instructions system includes an off-on control switch.

In some preferred embodiments of the present invention the vision applications training methodology for environments where it is appropriate to prevent head tilting the step a) involves using the vision applications training device, wherein the speaking tilt alarm system includes an off-on control switch.

In some preferred embodiments of the present invention the vision applications training device the first component and the second component are connected to one another by a movement mechanism selected from the group consisting of a rotation mechanism, a slide mechanism and a stretch mechanism.

In some preferred embodiments of the present invention the vision applications training device the first component is an elastic component and the second component is a non-elastic component being connected to one another to create a closed expandable contractible loop.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a diagrammatic representation of details and options for the present invention vision applications training device;

FIG. 2 is a side view of an embodiment of the present vision applications training device with a rotation mechanism in an open position;

FIG. 3 is a side view of the embodiment of the present vision applications training device shown in FIG. 2 in its closed position.

FIG. 4 is a side view of an embodiment of a present invention vision applications training device showing a closed loop device with an elastic component and a non elastic component;

FIG. 5 is a side view of another embodiment of a present invention vision applications training device showing a rotation mechanism with a single open and single closed position;

FIG. 6 is a side view of another embodiment of a present invention vision applications training device showing a closed loop device with two non elastic components that securely slide together; and,

FIG. 7 is an enlarged cutaway view of an embodiment of the locking mechanism shown in FIG. 1 and FIG. 2.

### DETAILED DESCRIPTION OF THE EMBODIMENTS

Referring now in detail to the drawings wherein like reference numerals designate corresponding parts throughout the several views, various embodiments of the present invention are shown.

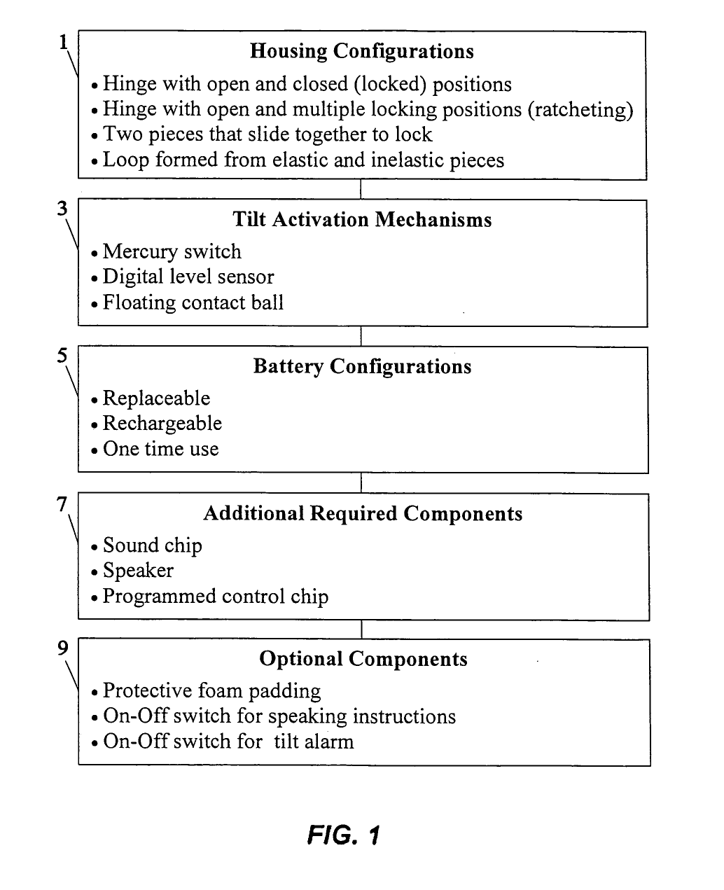

FIG. 1 is a diagrammatic representation of details and options for the present invention vision applications training device. The Housing Configurations 1 block details four possible embodiments of the main housing. The first embodiment described in Housing Configurations 1 block is a hinged rotation mechanism with two distinct locking positions. The first position is an open position for placing or removing the device from the ear, while the second is a closed position for securely holding the device to the ear.

The second Housing Configuration 1 described is a hinged rotation mechanism with multiple locking positions. A ratcheting type mechanism may be used to allow the two components of the housing of the device to be locked into multiple positions relative to each other, permitting the device to be positioned as needed for a secure fit on the ear.

The third Housing Configuration 1 described is a slide mechanism. The two components of the housing will have complimentary slide mechanisms that allow them to be slid together into a secure locked position for placement on the ear when in use.

The fourth Housing Configuration 1 described is a closed loop formed by an elastic and a non elastic component of the present device housing. The two components are securely connected at all times and sized to that the device may be slid over the ear comfortably and will securely hold the device in place while in use.

The Tilt Activation Mechanism 3 block describes three possible embodiments of the tilt activation mechanism used in the tilt alarm system. The first embodiment is a mercury switch. A mercury switch may be mounted within the housing in a non-horizontal orientation such that the globule of mercury contained within the mercury switch closes the tilt alarm circuit when it is at a predetermined angle from horizontal.

The second embodiment of the Tilt Activation Mechanism 3 described is a digital level sensor. A digital level sensor may be mounted within the housing such that the tilt alarm system is activated when a predetermined tilt angle from horizontal is detected.

The third embodiment of the Tilt Activation Mechanism 3 described is a floating contact ball. A floating contact ball may be mounted within the housing in a non-horizontal orientation such that the contact ball contained within the device closes the tilt alarm circuit when it is at a predetermined angle from horizontal.

The Battery Configurations 5 block of FIG. 1 details three possible embodiments of the battery used to power the tilt alarm system. While the actual battery may use any conventional cell, it should fall into one of three subsets selected from the group consisting of replaceable, rechargeable, and one time use batteries. Replaceable batteries can be placed in the device such that they can easily be removed and replaced as needed. A rechargeable battery may be permanently mounted within the device housing and provided with a charging mechanism, or may consist of a rechargeable battery that can be removed for charging. The third embodiment described in Battery Configurations 5 is a one time use battery. In this embodiment the entire present invention vision applications training device is considered disposable and may be thrown away after use.

In addition to the Housing configurations 1, Tilt Activation Mechanism 3, and Battery Configurations 5 described above, Additional Required Components 7 are needed for the present invention vision applications training device to function properly. A sound chip having at least one speaking command is needed to alert the user of the position of the device. The speaker relays the signals of the sound chip to the user through audible alarms or speaking commands. Finally, a programmed control chip is required to control interactions between all components of the present invention vision applications training device.

There are also a number of Optional Components 9 that are not required for the present invention vision applications training device to function properly, but rather improve comfort and usability of the device. While it is expected that the device be made out of a material that does not irritate the skin of the user, such as rubberized plastics, additional protective foam padding may be applied to the device. By adding protective foam padding, device comfort and fit can be improved while providing additional protection in the event of an impact to the device.

The present invention vision applications training device may also be fitted with On-off switches for the speaking commands of tilt alarm system. An On-off switch for the at least one speaking command may allow the user of the present invention to select between a simple audio alarm and speaking commands. An On-off switch for the tilt alarm system allows the entire device to be shut off when the device is not in use to preserve the battery.

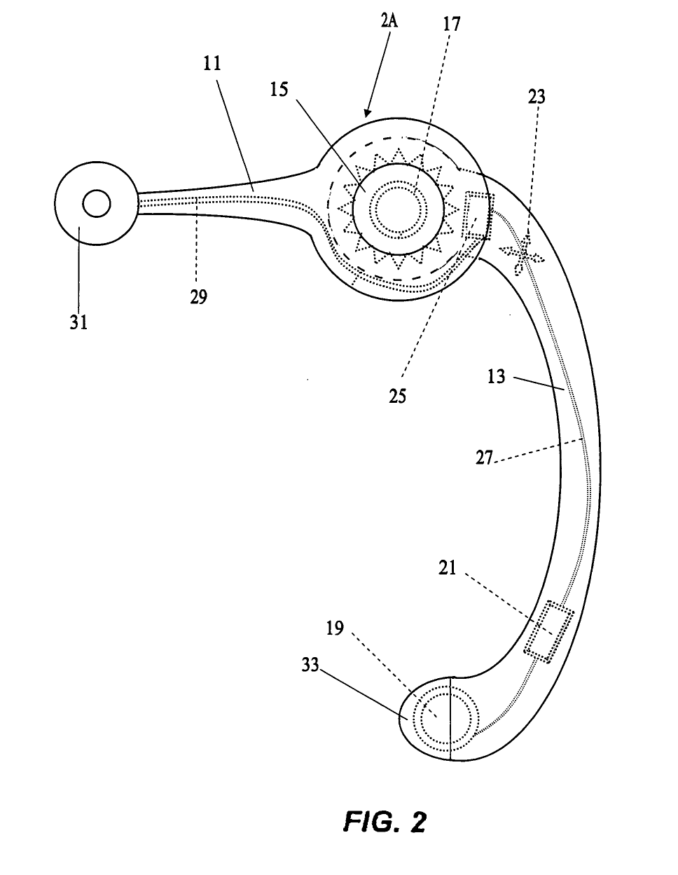

FIG. 2 is a side view of an embodiment of the present vision applications training device with a rotation mechanism in an open position. The training device 2A is formed by the first housing component 11 and the second housing component 13. First housing component 11 is designed to be placed over the ear and is attached to the second housing component 13. The second housing component 13 is sized to comfortably fit behind the ear of the user and is made of a non abrasive non elastic material such as rubberized plastic. The first housing component 11 and the second housing component 13 are not positioned on the same plane, but offset from each other to facilitate proper fit on the ear of the user. Locking mechanism 15 allows first housing component 11 and the second housing component 13 to swing open and closed when depressed out of the locked position. The first housing component 11 and the second housing component 13 can be locked into place by removing pressure from locking mechanism 15, which is returned to the locked position by spring 17.

The numerous tilt alarm components of the present invention are mounted within the training device 2A. Battery 19 is located within the second housing component 13 and can be removed by access door 33 for replacement. The battery 19 as shown can either be rechargeable or replaceable.

Connected to battery 19 is the programmed control chip 21. The programmed control chip 21 controls interactions between all components of the training device 2A.

The tilt activation mechanism 23 is shown mounted within the second housing component 13 in a non-horizontal orientation. The tilt activation mechanism 23 should be located within the training device 2A such that it is in a relatively consistent position on all users to facilitate proper orientation. The tilt activation mechanism 23 should be selected from the group consisting of a mercury switch, a digital level, and a floating contact ball switch.

The sound chip 25 is located within the second housing component 13. The sound chip 25 stores the at least one speaking command to be issued should the tilt activation means 23 be at a predetermined angle as set by the programmed control chip 21. The sound chip 25 is able to receive downloadable commands, such as pro-player voices, celebrity voices, and other commands. This may be accomplished through the use of wave files or other suitable transferable file types. Wiring circuit 27 connects the battery 19, programmed control chip 21, tilt activation mechanism 23, and sound chip 25.

Once the tilt activation mechanism 23 is at a predetermined angle from horizontal as set by the programmed control chip 21, sound chip 25 sends a signal along second wiring circuit 29 to the speaker 31. Second wiring circuit 29 is mounted in first housing component 11 such that rotation of first housing component 11 relative to second housing component 13 about locking mechanism 15 is not impeded. Speaker 31 is mounted at the end of first housing component 11, which is at the maximum open position to allow easy placement and removal of the device on the user's ear.

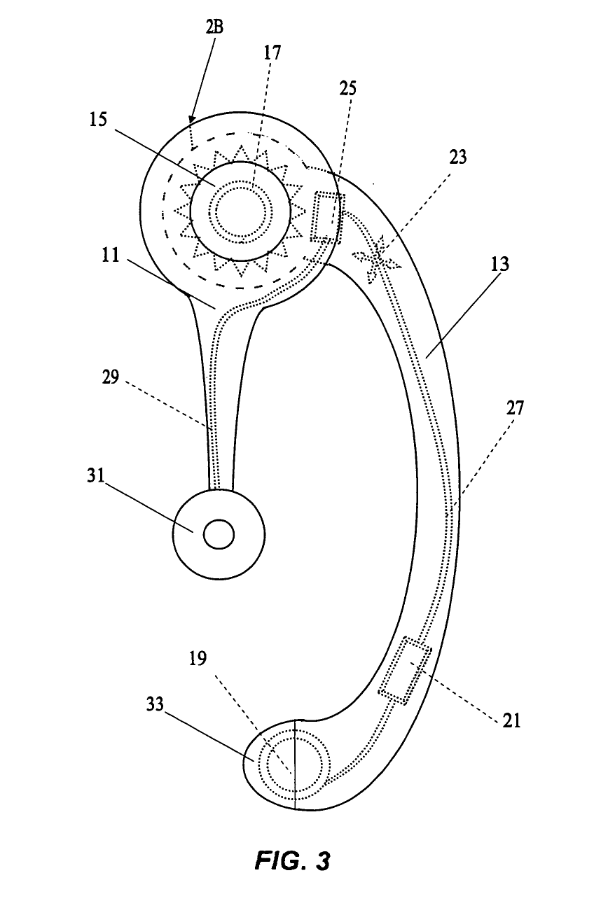

FIG. 3 is a side view of an embodiment of the present vision applications training device as described in FIG. 2 in a closed position. The training device 2B is formed by the first housing component 11 and the second housing component 13. The first housing component 11 is designed to be placed over the ear and is attached to the second housing component 13. The second housing component 13 is sized to comfortably fit behind the ear of the user and is made of a non abrasive non elastic material such as rubberized plastic. The first housing component 11 and the second housing component 13 are not positioned on the same plane, but offset from each other to facilitate proper fit on the ear of the user. Locking mechanism 15 the first housing component 11 and the second housing component 13 to swing open and closed when depressed out of the locked position. The first housing component 11 and the second housing component 13 can be lock into place by removing pressure from locking mechanism 15, which is returned to the locked position by spring 17.

The numerous tilt alarm components of the training device 2B are mounted within the first housing component 11 and the second housing component 13. Battery 19 is located within the second housing component 13 and can be removed by access door 33 for replacement. The battery 19 as shown can either be rechargeable or replaceable.

The battery 19 is connected to the programmed control chip 21. The programmed control chip 21 controls interactions between all components of the training device 2B.

The tilt activation mechanism 23 is shown mounted within the second housing component 13 in a non-horizontal orientation. The tilt activation mechanism 23 should be located within the training device 2B such that it is in a relatively consistent position on all users to facilitate proper orientation. The tilt activation mechanism 23 should be selected from the group consisting of a mercury switch, a digital level, and a floating contact ball switch.

The sound chip 25 is located within the second housing component 13. The sound chip 25 stores the at least one speaking command to be issued should the tilt activation means 23 be at a predetermined angle as set by the programmed control chip 21. Wiring circuit 27 connects the battery 19, programmed control chip 21, tilt activation mechanism 23, and sound chip 25.

Once the tilt activation mechanism 23 is at a predetermined angle from horizontal as set by the programmed control chip 21, sound chip 25 sends a signal along second wiring circuit 29 to the speaker 31. Second wiring circuit 29 is mounted in first housing component 11 such that rotation of first housing component 11 relative to second housing component 13 about locking mechanism 15 is not impeded. Proper placement of the speaker 31 relative to the user's ear can be achieved by allowing locking mechanism 15 to be locked in multiple positions. Speaker 31 is mounted at the end of first housing component 11 and is designed to be placed in or over the ear canal of the user. It is also possible for a speaker 31 placed forward over the tragus during use.

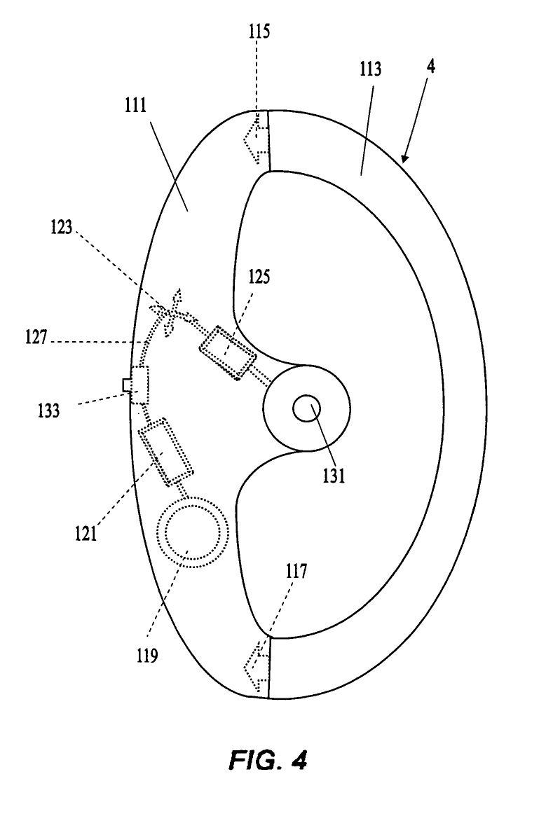

FIG. 4 is a side view of an embodiment of the present vision applications training device showing a closed loop device with an elastic component and a non elastic component. The training device 4 is formed by the first housing component 11 and the second housing component 13. The first housing component 111 is non elastic and is designed to be placed over the ear and is attached to the second housing component 113. The second housing component 113 is elastic to allow it to be stretched over the ear while placing the present invention present vision applications training device. When in position the second housing component 113 holds the first component of the housing device 111 firmly in place. The first housing component 11 and the second housing component 13 are not positioned on the same plane, but offset from each other to facilitate proper fit on the ear of the user. Locking mechanisms 115 and 117 connect the first housing component 11 and the second housing component 13 together. Locking mechanisms 115 and 117 are shown as a permanent connection consisting of a male and female locking component integrated into first housing component 111 and second housing component 113, however other permanent locking mechanisms may be used.

The numerous tilt alarm components of the training device 4 are mounted the first housing component 11 and the second housing component 13. Battery 119 is located within the first housing component 111 is shown permanently mounted within. The battery 119 as shown can be recharged using an external charging unit not pictured.

The next component of the training device 4 shown is the programmed control chip 121. The programmed control chip 121 controls interactions between all components of the training device 4.

An optional On-off switch 133 for the tilt alarm is shown. The On-off switch allows the present invention vision applications training device to be turned off when not in use to conserve battery 119.

The tilt activation mechanism 123 is shown mounted within the first housing component 111 in a non-horizontal orientation. The tilt activation mechanism 123 should be located within the present invention vision applications training device such that it is in a relatively consistent position on all users to facilitate proper orientation. The tilt activation mechanism 123 should be selected from the group consisting of a mercury switch, a digital level, and a floating contact ball switch.

The sound chip 125 is located within the first housing component 111. The sound chip 125 stores the at least one speaking command to be issued should the tilt activation means 123 be at a predetermined angle as set by the programmed control chip 121. Wiring circuit 127 connects the battery 119, programmed control chip 121, tilt activation mechanism 123, and sound chip 125.

Once the tilt activation mechanism 123 is at a predetermined angle from horizontal as set by the programmed control chip 121, sound chip 125 sends a signal along wiring circuit 127 to the speaker 131. Speaker 131 is mounted along first housing component 111 and is designed to be placed in or over the ear canal of the user. It is also possible for a speaker 131 to be positioned forward, over the tragus during use.

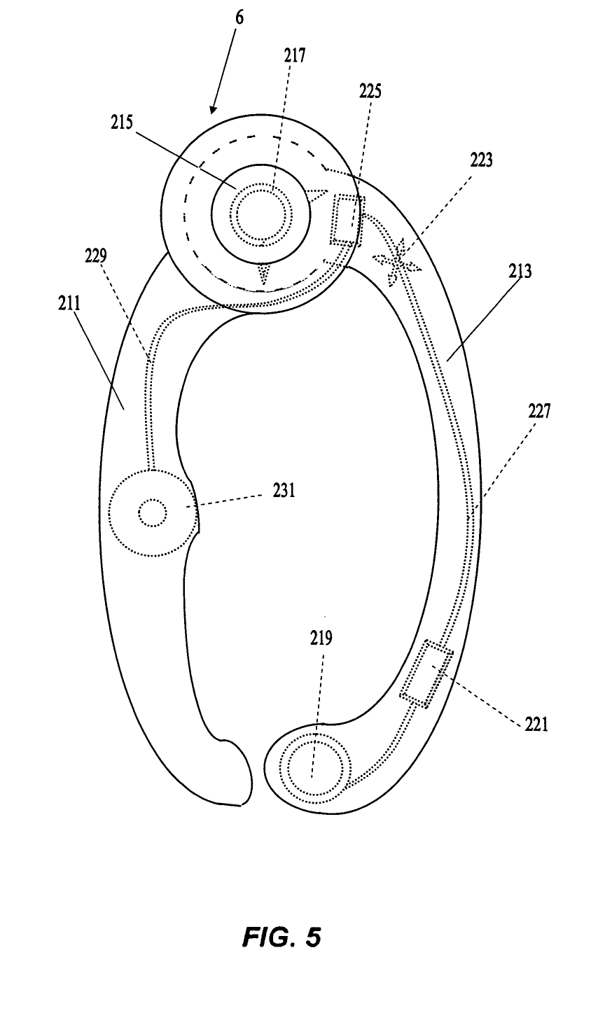

FIG. 5 is a side view of an embodiment of the present vision applications training device consisting of with a rotation mechanism in a closed position. Unlike the embodiment shown in FIG. 2 and FIG. 3, the first housing component 211 and second housing component 213 of training device 6 form a nearly complete loop when locked in the closed position. The first housing component 211 is designed to be placed over the ear and is attached to the second housing component 213. The second housing component 213 is sized to comfortably fit behind the ear of the user and is made of a non abrasive non elastic material such as rubberized plastic. The first housing component 211 and second housing component 213 are not positioned on the same plane, but offset from each other to facilitate proper fit on the ear of the user. Locking mechanism 215 allows device housing components 211 and 213 to swing open and closed when depressed out of the locked position. The first housing component 211 and second housing component 213 can be lock into an open or closed position by removing pressure from locking mechanism 215, which is returned to the locked position by spring 217.

The numerous tilt alarm components of the training device 6 are mounted within the housing components 211 and 213. Battery 219 is located within the second housing component 213. As shown, battery 219 is not removable and can either be considered a rechargeable or one time use battery.

The battery 219 is connected to the programmed control chip 221. The programmed control chip 221 controls interactions between all components of the training device 6.

The tilt activation mechanism 223 is shown mounted within the second housing component 213 in a non-horizontal orientation. The tilt activation mechanism 223 should be located within the present invention vision applications training device such that it is in a relatively consistent position on all users to facilitate proper orientation. The tilt activation mechanism 223 should be selected from the group consisting of a mercury switch, a digital level, and a floating contact ball switch.

The sound chip 225 is located within the second housing component 213. The sound chip 225 stores the at least one speaking command to be issued should the tilt activation means 223 be at a predetermined angle as set by the programmed control chip 221. Wiring circuit 227 connects the battery 219, programmed control chip 221, tilt activation mechanism 223, and sound chip 225.

Once the tilt activation mechanism 223 is at a predetermined angle from horizontal as set by the programmed control chip 221, sound chip 225 sends a signal along second wiring circuit 229 to the speaker 231. Second wiring circuit 229 is mounted in first housing component 211 such that rotation of first housing component 211 relative to second housing component 213 about locking mechanism 215 is not impeded. Speaker 231 is mounted along the first housing component 211 so as to fit in or over the ear canal of the user when the device is closed. It is also possible for a speaker 231 placed forward over the tragus during use.

Unlike the embodiment of the present invention present vision applications training device shown in FIG. 2 and FIG. 3, the training device 6 of FIG. 5 has only two locking positions allowed by locking mechanism 215. An open position is provided for placing and removing the device and a closed position is provided for securing the device on the ear of the user.

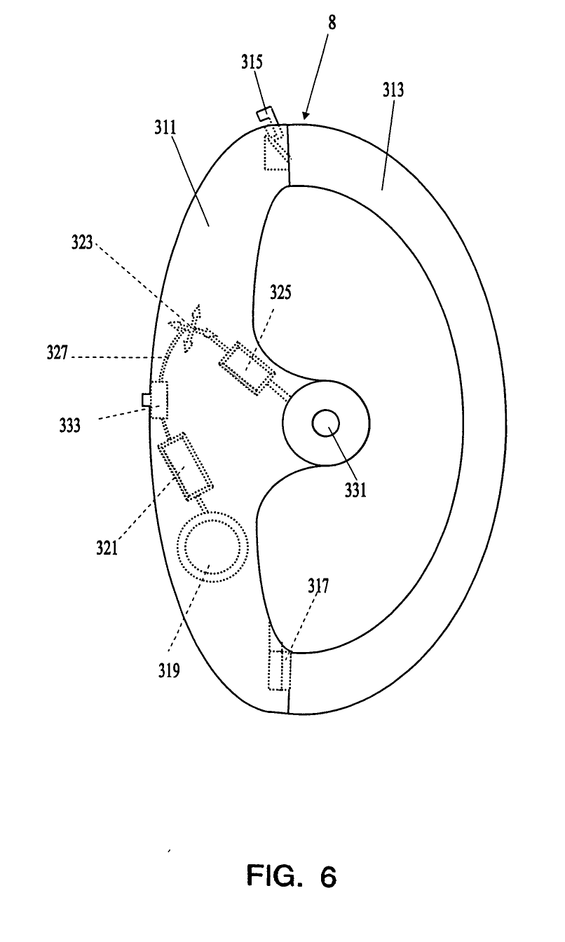

FIG. 6 is a side view of an embodiment of the present vision applications training device showing a closed loop training device 8 consisting of a first housing component 311 and a second housing component 313 with a sliding lock mechanism for attaching the two. The first housing component 311 is designed to be placed over the ear. The second housing component 313 is designed to be placed behind the ear while fitting the device. When in position the second housing component 313 holds the first housing component 311 firmly in place through slide mechanism 317 and locking mechanism 315. Slide mechanism 317 is a protrusion on second housing component 313 that fits into a corresponding channel in first housing component 311. A locking mechanism 315 consists of a male clip system on second housing component 313 that clips onto first housing component 311, although other similar locking mechanisms may be used. The first housing component 311 and second housing component 313 are not positioned on the same plane, but offset from each other to facilitate proper fit on the ear of the user.

The numerous tilt alarm components of the training device 8 are mounted within the housing components 311 and 313. Battery 319 is located within the first housing component 311 is shown permanently mounted within. The battery 319 as shown can be recharged using an external charging unit not pictured. Battery 319 may also be considered a one time use device.

The battery 319 is connected to the programmed control chip 321. The programmed control chip 321 controls interactions between all components of the training device 8.

An optional On-off switch 333 for the training device 8 is shown. The On-off switch 333 allows the present invention vision applications training device 8 to be turned off when not in use to conserve battery 319. It is also possible for On-off switch 333 to control the output of sound chip 325, switching the chip between speaking commands and non speaking commands as desired by the user.

The tilt activation mechanism 323 is shown mounted within the first housing component 311 in a non-horizontal orientation. The tilt activation mechanism 323 should be located within the training device 8 such that it is in a relatively consistent position on all users to facilitate proper orientation. The tilt activation mechanism 323 should be selected from the group consisting of a mercury switch, a digital level, and a floating contact ball switch.

The sound chip 325 is located within the first housing component 311. The sound chip 325 stores the at least one speaking command to be issued should the tilt activation means 323 be at a predetermined angle as set by the programmed control chip 321. Wiring circuit 327 connects the battery 319, programmed control chip 321, On-off switch 333, tilt activation mechanism 323, sound chip 325, and speaker 331.

Once the tilt activation mechanism 323 is at a predetermined angle from horizontal as set by the programmed control chip 321, sound chip 325 sends a signal along wiring circuit 327 to the speaker 331. Speaker 331 is mounted along first housing component 311 and is designed to be placed in or over the ear canal of the user. It is also possible for a speaker 331 to be positioned forward, over the tragus during use.

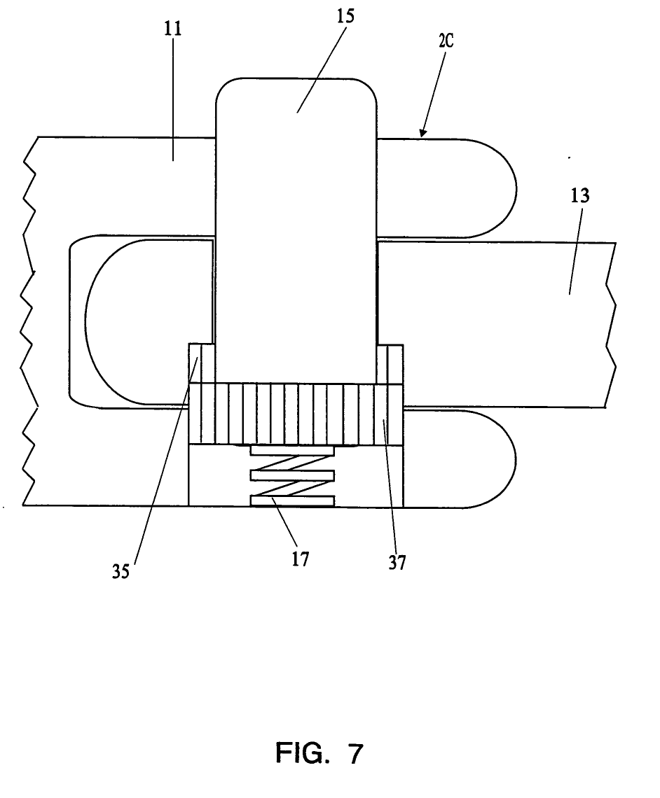

FIG. 7 is an enlarged cutaway view of an embodiment of the locking mechanism used in training device 2C as shown in FIG. 1 and FIG. 2. The interaction of locking mechanism 15, first housing component 11 and second housing component 13 is illustrated in more detail in this figure. Locking mechanism 15 has a geared flare 37 at one end. A female complementary geared recession 35 is provided in second housing component 13. When no pressure is applied to locking mechanism 15, spring 17 presses locking mechanism 15 firmly into second housing component 13, locking geared flare 37 with the geared recess 35 in second housing component 13. When sufficient pressure is applied to locking mechanism 15, spring 17 compresses, and geared flare 37 completely disengages from geared recess 35 in second housing component 13. This allows second housing component 13 to rotate relative to first housing component 11. When a desired fit is achieved, the pressure is released from locking mechanism 15 and the device is held in place on the user's ear.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A vision applications training device to assist a user in preventing head tilting in environments where it is appropriate, which comprises:
a) a main housing;
b) an ear attachment means connected to said main housing, said ear attachment means having a first component and second component being connected to one another so as to be movable relative to one another from a first position, being an open position, to a second position, being a closed position, and arranged to create said closed position for fixed placement on a human ear;
c) a speaking tilt alarm system contained within said main housing that includes a battery, a sound chip, a speaker, a tilt activation mechanism and functional connections, said sound chip having at least one speaking command;
wherein a user may attach said device to said user's ear and when said user's head tilts at least a predetermined angle from horizontal, said tilt activation mechanism activates said chip and said at least one speaking command is played through said speaker.

2. The vision applications training device of claim 1 wherein said main housing includes a battery access means to permit battery replacement.

3. The vision applications training device of claim 1 wherein said tilt activation mechanism is a mercury switch with a non-horizontal orientation of predetermined angle.

4. The vision applications training device of claim 1 wherein said tilt activation mechanism is a digital level sensor.

5. The vision applications training device of claim 1 wherein said tilt activation mechanism is a floating contact ball with a non-horizontal oriented ball track.

6. The vision applications training device of claim 1 wherein said device further includes padding attached to a portion of said device to reduce impact-based head injury.

7. The vision applications training device of claim 1 further including:
d) a speaking instructions system that further at least includes a battery connection, a sound chip, a speaker and a programmed control chip for playing said sound chip at preset intervals, said sound chip having at least one speaking instruction.

8. The vision applications training device of claim 7 wherein said speaking instructions system battery connection is functionally connected to said speaking tilt alarm system battery.

9. The vision applications training device of claim 7 wherein said speaking instructions system includes an off-on control switch.

10. The vision applications training device of claim 1 wherein said speaking tilt alarm system includes an off-on control switch.

11. The vision applications training device of claim 1 wherein said first component and said second component are connected to one another by a movement mechanism selected from the group consisting of a rotation mechanism, a slide mechanism and a stretch mechanism.

12. The vision applications training device of claim 1 wherein said first component is an elastic component and said second component is a non-elastic component being connected to one another to create a closed expandable-contractible loop.

13. A vision applications training device to assist a user in preventing head tilting in environments where it is appropriate, which comprises:
a) a main housing;
b) an ear attachment means connected to said main housing, said ear attachment means having a first component and second component being connected to one another so as to be movable relative to one another from a first position, being an open position, to a second position, being a closed position, and arranged to create said closed position for fixed placement on a human ear;
c) a speaking tilt alarm system contained within said main housing that includes a battery, a sound chip, a speaker, a tilt activation mechanism and functional connections, said sound chip having at least one speaking command;
wherein a user may attach said device to said user's ear and when said user's head tilts at least a predetermined angle from horizontal, said tilt activation mechanism activates said chip and said at least one speaking command is played through said speaker.

14. The vision applications training methodology for environments where it is appropriate to prevent head tilting of claim 13 wherein said step a) involves using said vision applications training device, wherein said main housing includes a battery access means to permit battery replacement.

15. The vision applications training methodology for environments where it is appropriate to prevent head tilting of claim 13 wherein said step a) involves using said vision applications training device, wherein said tilt activation mechanism is a mercury switch with a non-horizontal orientation of predetermined angle.

16. The vision applications training methodology for environments where it is appropriate to prevent head tilting of claim 13 wherein said step a) involves using said vision applications training device, wherein said tilt activation mechanism is a digital level sensor.

17. The vision applications training methodology for environments where it is appropriate to prevent head tilting of claim 13 wherein said step a) involves using said vision applications training device, wherein said tilt activation mechanism is a floating contact ball with a non-horizontal oriented ball track.

18. The vision applications training methodology for environments where it is appropriate to prevent head tilting of claim 13 wherein said step a) involves using said vision applications training device, wherein said device further includes padding attached to a portion of said device to reduce impact-based head injury.

19. The vision applications training methodology for environments where it is appropriate to prevent head tilting of claim 13 wherein said step a) involves using said vision applications training device, wherein the vision applications training device of claim 1 further includes:
i. a speaking instructions system that further at least includes a battery connection, a sound chip, a speaker and a programmed control chip for playing said sound chip at preset intervals, said sound chip having at least one speaking instruction.

20. The vision applications training methodology for environments where it is appropriate to prevent head tilting of claim 19 wherein said step a) involves using said vision applications training device, wherein said speaking instructions system battery connection is functionally connected to said speaking tilt alarm system battery.

21. The vision applications training methodology for environments where it is appropriate to prevent head tilting of claim 19 wherein said step a) involves using said vision applications training device, wherein said speaking instructions system includes an off-on control switch.

22. The vision applications training methodology for environments where it is appropriate to prevent head tilting of claim 12 wherein said step a) involves using said vision applications training device, wherein said speaking tilt alarm system includes an off-on control switch.

23. The vision applications training device of claim 13 wherein said first component and said second component are connected to one another by a movement mechanism selected from the group consisting of a rotation mechanism, a slide mechanism and a stretch mechanism.

24. The vision applications training device of claim 13 wherein said first component is an elastic component and said second component is a non-elastic component being connected to one another to create a closed expandable contractible loop.
